(19) United States
(12) Patent Application Publication
(10) Pub. No.: US 2018/0212272 A1
(43) Pub. Date: Jul. 26, 2018

(54) Lithium-Ion Cell

(71) Applicant: Bayerische Motoren Werke Aktiengesellschaft, Muenchen (DE)

(72) Inventors: Thomas WOEHRLE, Muenchen (DE); Holger HAIN, Ismaning (DE); Barbara STIASZNY, Eurasburg (DE)

(21) Appl. No.: 15/927,307

(22) Filed: Mar. 21, 2018

Related U.S. Application Data
(63) Continuation of application No. PCT/EP2016/069108, filed on Aug. 11, 2016.

(30) Foreign Application Priority Data
Sep. 22, 2015 (DE) 10 2015 218 189.8

(51) Int. Cl. H01M 10/0525; H01M 4/525; H01M 4/04

(52) U.S. Cl. CPC H01M 10/0525; H01M 2004/028; H01M 4/04; H01M 4/525

(57) ABSTRACT

A lithium-ion cell that includes a positive electrode having a partially lithiated material as an active material for the positive electrode, and a negative electrode having a partially lithiated material as an active material for the negative electrode.

### CROSS REFERENCE TO RELATED APPLICATIONS

This application is a continuation of PCT International Application No. PCT/EP2016/069108, filed Aug. 11, 2016, which claims priority under 35 U.S.C. § 119 from German Patent Application No. 10 2015 218 189.8, filed Sep. 22, 2015, the entire disclosures of which are herein expressly incorporated by reference.

### BACKGROUND AND SUMMARY OF THE INVENTION

The present invention relates to a lithium-ion cell. The present invention also relates to a method for producing a lithium-ion cell.

According to conventional art—see, for example, T. Wöhrle in chapter 9, R. Korthauser, Handbuch Lithium-Ionen-Batterien, Springer Verlag Berlin Heidelberg 2013 on (secondary) lithium-ion cells, or see, for example, the specification EP0017400A1—lithium-ion cells (LICs) are produced with a fully delithiated anode (typically a graphite anode without lithium content) and with a 100%-lithiated cathode (e.g., a lithium cobalt oxide (LCO) cathode with maximum lithium content in the lattice structure in the form of LiCoO₂).

After the closing of the casing of an LIC in production, the cell is initially in the uncharged state; that is, the graphite of the negative electrode (also referred to as the anode) is to start with not loaded with lithium (Li). The cyclable lithium is initially present entirely in the positive electrode (also referred to as the cathode).

In order to make the LIC ready to use for an application, it must undergo first-time charging, referred to as formation. In this procedure, an LIC undergoes first-time charging up to the permitted end-of-charge voltage, and subsequently, optionally, undergoes first-time discharging down to the permitted end-of-discharge voltage. During the first charging, a protective layer is formed around the graphite surface of the negative electrode, this layer being referred to as the electrode-electrolyte interface (solid electrolyte interface, SEI for short). The SEI is a lithium-ion conductor and includes permanent, Li-containing compounds, meaning that this bound amount of Li, subsequently and over the long term, is not available for cycling. These compounds which reflect the loss of Li frequently comprise Li₂CO₃, which is bound typically as an electrolyte decomposition product in the SEI and no longer participates in further electrochemical reactions.

For example, according to T. Wöhrle in R. Korthauser, Handbuch Lithium-Ionen-Batterien, Springer Verlag Berlin Heidelberg 2013, lithium-ion cells used in the context of deployment in smartphones are predominantly pouch cells which comprise LiCoO₂ and graphite. During first charging, the cell is charged to 4.2 V; under this condition, around 50 mol % of the Li ions are deintercalated from the LiCoO₂. The first intercalation of these Li ions into the graphite anode is accompanied by decomposition of the electrolyte at the anode, and decomposition products such as Li₂CO₃ contain lithium ions, which are therefore not incorporated into the anode. The formation of the electrolyte decomposition products is irreversible and the lithium thus bound is no longer available for further electrochemical reaction or for cycling. In the first discharging and further charge/discharge procedures, accordingly, there are fewer Li ions available for cycling. The first discharge capacity is therefore lower than the first charge capacity. This loss is also referred to as formation loss. In quantitative terms, it is dependent in particular on the type of anode used and on the electrolyte.

At formation, the following reaction occurs:

[Cathode: 2.4 LiCoO₂]+[Anode: C₆ (graphite)]→

[Cathode: 2.4 Li_{0.5}CoO₂]+[Anode: LiC₆]+0.1 Li₂CO₃ (SEI).

In the following discharge reaction, excess delithiated cathode material remains in the form of Li_{0.5}CoO₂ as loss material, which is carried as an excess in the LIC without participating in cycling processes. In the case of a negative electrode made of natural graphite in combination with a positive LCO electrode, the loss material amounts to about 10% of the active LCO—in other words, the LCO material must be provided with an excess of 10%, relative to the nominal capacity, at the production stage.

It is an object of the present invention to provide an improved lithium-ion cell and an improved method for producing a lithium-ion cell.

As used herein, unless otherwise indicated, the terms “lithium cell”, “lithium battery”, and “conversion cell” are not differentiated and are referred to collectively as “lithium-ion cell (LIC)”.

In accordance with the invention, the positive electrode of the lithium-ion cell (LIC) includes a partially lithiated material as the active material, and the negative electrode of the LIC includes a partially lithiated material as the active material.

As defined herein, “partially lithiated” means that the material contains at least partially active lithium, i.e., lithium which has taken part in the redox reactions when the LIC is cycled. Active material is understood as the reactive material which, in the electrochemical discharging and charging reactions of the LIC, contributes to the delivery or storage, respectively, of electrochemically bound electrical energy.

It is particularly advantageous if the partially lithiated material of the positive electrode is the active starting material of the positive electrode, and if the partially lithiated material of the negative electrode is the active starting material of the negative electrode.

This means, in other words, that when the electrodes are installed into an LIC, i.e., during installation into a casing of the later LIC in the production operation, the starting material of the active material that is introduced is a material which is lithiated at both types of electrode. This improvement has positive consequences for the lifetime and the energy density and also for the specific energy of the LIC.

As used herein, the terms “starting material” and “active starting material” refer to the material which during production is/has been introduced into the LIC and which after the production of the LIC, in the operation of the LIC, as a secondary electrochemical storage device, serves as active material. Synonymous with this is that the LIC is/has been produced in already partially charged form.

According to a further embodiment of the invention, the starting material of the positive electrode is a mixture of a fluoride of a metal, an elemental metal, and lithium fluoride (LiF).

An exemplary mixture may include iron fluoride (FeF₃), iron (Fe), and lithium fluoride (LiF).

The starting material of the negative electrode is advantageously a mixture of an oxide of a metal, an elemental metal, and lithium oxide (Li₂O).

An exemplary mixture may include iron oxide (Fe₂O₃), iron (Fe), and lithium oxide (Li₂O).

According to one particular variant, the fraction of the fluoride of the metal in the starting material of the positive electrode is at least 50 mol % and, optionally or additionally, the fraction of the oxide of the metal in the starting material of the negative electrode is at most 50 mol %.

With the stated composition, the LIC is 50% charged right from the moment of filling with electrolyte. Accordingly, with the sealing of the casing, without an external current circuit yet being connected, the assembled LIC is in a state which is advantageous for its further handling. This is because there is neither a high self-discharge as in the case of even higher states of charge, and nor is the incidence of exhaustive discharge likely. In order to minimize other damage mechanisms, such as decomposition of the electrolyte on the metal particles in the cathode, for example, the state of charge is at least at 50%, preferably above 50%, and the metal oxide fraction in the anode is at most 50%, preferably, at exactly that figure below 50% that corresponds to the formation loss. This gives the LIC an optimum balance in terms of being equipped with active material.

It is an advantage if the metal is iron, nickel, or copper.

Partially lithiated electrodes through which the active material is introduced into the LIC have the advantage that the losses on first-time complete charging of the LIC (also referred to as formation) are extremely low, and in particular are lower than in the case of conventional LICs. Lower formation losses are accompanied by a higher energy density of the LIC (in Wh/L) and a more high specific energy (in Wh/kg). The low formation losses come about as a result of the reaction behavior of the starting materials. The reaction behavior is described below using three exemplary embodiments.

As a result of the low formation losses it is possible to use the starting material virtually without excess, i.e., without reserves for formation, in order to achieve a defined nominal capacity of the LIC. Consequently, a higher lithium content can be achieved in the LIC than if the same level of material was used in the context of conventional installation of electrodes with a fully lithiated cathode (such as LiCoO₂) according to conventional art. Given the fact that, in particular, expensive LiCoO₂ or LiNiO₂ is used in order to compensate formation losses, a method which merely employs lithium is more cost-effective.

The increased lithium content of the LIC is accompanied immediately by a number of advantages, which are those of a higher energy density and a higher specific energy. Moreover, because of the partial lithiation of the anode, which at full charge is fully lithiated, there is also a reduction in the current consumed with the first charging of the respective cell, implying a reduction in costs of the production process.

The possibility exists, moreover, by virtue of the partial lithiation of the two electrodes, during the production of an LIC, to carry out the first-time cycling at a later point in time, as for example after the assembly of the LIC, or at the premises of the end user. This advantage derives from the fact that a cell equipped with partially lithiated electrodes can be used instantaneously after installation.

In addition, because of the avoidance of “dead material” as a result of the prior lithiation of the two electrodes in accordance with the invention, the financial outlay for, in particular, nickel-containing or cobalt-containing active material during the production of the LIC is reduced.

Moreover, the installation of partially lithiated electrodes is compatible, from the present-day standpoint, in future onward developments of the lithium-ion battery technology. It is likely, for example, that partially lithiated electrodes will have particularly rich economic prospects in the context of lithium systems with silicon-containing anodes and/or with cathode conversion materials.

The present invention also provides a method for producing a lithium-ion cell which includes the steps of mixing a first partially lithiated starting material for the positive electrode, mixing a second partially lithiated starting material for the negative electrode, producing the positive electrode with the first partially lithiated starting material as the active material, producing the negative electrode with the second partially lithiated starting material as the active material, installing the positive electrode and the negative electrode into a cell casing, and sealing the cell casing.

The steps follow in direct or indirect order as given, and in the case of indirect order, there may be other production procedures between the steps shown, and, in the case of direct order, the steps follow one another directly without other intervening steps.

According to one preferred embodiment, in the method of producing the lithium ion cell of the invention, the first partially lithiated starting material is a mixture of a fluoride of a metal, an elemental metal, and lithium fluoride (LiF).

One exemplary mixture may comprise iron fluoride (FeF₃), iron (Fe), and lithium fluoride (LiF). Another exemplary mixture may comprise Li₂S and S₈.

It is useful, moreover, if in the context of the method, the second partially lithiated starting material is a mixture of an oxide of a metal, an elemental metal, and lithium oxide (Li₂O).

One exemplary mixture may comprise iron oxide (Fe₂O₃), iron (Fe), and lithium oxide (Li₂O).

According to one particular variant of the method, in the context of the method, the fraction of the fluoride of the metal in the first partially lithiated starting material is at least 50 mol % and, optionally or additionally, the fraction of the oxide of the metal in the second partially lithiated starting material is at most 50 mol %.

With the stated composition, the LIC is 50% charged relative to the nominal capacity right from the moment of filling with electrolyte. Accordingly, with the sealing of the casing, without an external current circuit yet being connected, the assembled LIC is in a state which is advantageous for its further handling. This is because there is neither a high self-discharge as in the case of even higher states of charge, and nor is the incidence of exhaustive discharge likely. In order to minimize other damage mechanisms, such as decomposition of the electrolyte on the metal particles in the cathode, for example, the state of charge is at least at 50%, preferably above 50%, and the metal oxide fraction in the anode is at most 50%, preferably at exactly that figure below 50% that corresponds to the formation loss. Furthermore, in the event of accidents during the processing of the LIC (e.g., in the case of an external short circuit), the electrical hazard at a lower state of charge is lower than in the case of the higher state of charge.

It is an advantage for the method if the metal is iron, nickel, or copper.

The production method is particularly advantageous. The installation of partially lithiated electrodes is readily manageable on the industrial scale. The possibility exists, moreover, by virtue of the partial lithiation of the two electrodes, during the production of an LIC, to carry out the first-time cycling at a later point in time, as for example after the assembly of the LIC, or at the premises of the end user. This advantage derives from the fact that a cell equipped with partially lithiated electrodes can be used instantaneously after installation.

The invention is based on the considerations set out below:

Installed in present-day lithium-ion batteries (LIBs) are an anode, a cathode, and a separator which is impregnated with electrolyte. On assembly of the materials in this system, the cathode material contains all of the lithium ions (Li ions) which are intercalated and deintercalated into and out of the anode and cathode during the lifetime of the battery—see, for instance, the specification EP0017400A1. On the first-time cycling of the LIB, i.e., during the first charging of the battery, the solid electrolyte interface (SEI) layer is formed on the anode, and leads to an irreversible consumption of Li ions in unwanted secondary reactions. Furthermore, there are other reactions as well during the lifetime of a battery that irreversibly remove Li ions from the system. This diminishes the overall capacity of the battery, and right from the start of cycling, some of the active materials are in the form of inactive material, since the system no longer has sufficient Li ions available to lithiate all parts of the active material.

The formation losses during first-time cycling must be included in the calculation when manufacturing the LIB, in order to achieve a defined target capacity after formation. This results in some cases in considerable extra costs for the Li source, i.e., the cathode material, which is generally expensive. Moreover, the excess cathode material employed diminishes the specific energy of the LIB. As a result of the “dead material” which is present after formation, and which supplies Li ions only once, namely on formation, there is a reduction in the energy density and in the specific energy. This is a fundamental factor in all lithium-ion technologies where only one of the two electrodes supplies Li ions. On further cycling, the energy density and the specific energy are reduced even further, since the secondary reactions involving consumption of lithium proceed continuously. Examples of such secondary reactions are the reformation of the SEI on the anode in the case of damage (e.g., as a result of external influences), decomposition of the electrolyte through overcharging or on storage in high state of charge, moisture penetration of the cell, and, consequently, unwanted formation of hydrogen fluoride (HF).

The proposal is therefore that both the anode and the cathode be installed in partially lithiated form into the battery. This means that during installation, in other words prior to first-time cycling of the LIB, both electrodes already partially contain Li ions. As a result, the lithium content achievable in the lithium-ion cell, or in an LIB constructed of a plurality of similar lithium-ion cells, is higher than on conventional installation of a fully lithiated cathode in accordance with conventional art.

The increased lithium content of the LIB is accompanied immediately by a number of advantages, which are those of a higher energy density and a higher specific energy and increased service life. Moreover, because of the partial lithiation of the anode, which at full charge is fully lithiated, there is also a reduction in the current consumed with the first charging of the respective cell.

The possibility exists, moreover, by virtue of the partial lithiation of the two electrodes, during the production of a lithium-ion cell, to carry out the first-time cycling at a later point in time, as for example after the assembly of an LIB from lithium-ion cells, or at the premises of the end user. This advantage derives from the fact that a cell equipped with partially lithiated electrodes can be used instantaneously after installation.

In addition, because of the avoidance of “dead material” (see above) as a result of the prior lithiation of the two electrodes in accordance with the invention, the financial outlay for active material during the production of the lithium-ion cell is reduced.

Moreover, the installation of partially lithiated electrodes is compatible, from the present-day standpoint, in future onward developments of the LIB technology. It is likely, for example, that partially lithiated electrodes will have particularly rich economic prospects in the context of lithium systems with silicon-containing anodes and/or with cathode conversion materials.

The invention is described below in relation to a preferred exemplary embodiment. Apparent from this description are further details, preferred embodiments, and developments of the invention.

According to a first exemplary embodiment, a lithium-ion cell is fitted during production with partially lithiated electrodes. The cathode is an iron (III) fluoride (FeF₃)-based electrode; the anode is an iron (III) oxide (Fe₂O₃)-based anode.

The cathode has a composition of approximately 25 mol % FeF₃ and 75 mol % Fe+3 LiF, i.e., 78 wt % of a combination of one stoichiometric part of elemental iron and three stoichiometric parts of lithium(I) fluoride.

The anode has a composition of approximately 50 mol % Fe₂O₃ and 50 mol % 2 Fe+3 Li₂O, i.e., 55 wt % of a combination of two stoichiometric parts of elemental iron and three stoichiometric parts of lithium (IV) oxide. Initially, therefore, i.e., on production of the cell, the anode is 50% charged (based on a fully charged state of 100% of the cell on maximum lithiation of the anode), and the cathode is 75% charged (based on a discharge state of 0% of the cell on maximum lithiation of the cathode).

Accordingly, the cathode is installed with an excess of lithium.

This is a result in particular of the course of reaction on first-time charging after the production of the lithium-ion cell, the formation. In this process, in accordance with the reaction below, there is a one-time build-up of a protective layer on the anode surface, namely the SEI (solid electrolyte interface):

(3 Fe+9 LiF+FeF₃)+(Fe₂O₃+2Fe+3 Li₂O)→4 FeF₃+(4 Fe+6 Li₂O)+1.5 Li₂CO₃ (SEI)

Lithium is bound irreversibly here, but without leading to the formation of unused active material, since products of the SEI-forming reaction are the cathodic active material FeF₃ and the anodic active material 2 Fe+3 Li₂O, each of which are reactants in the discharge reaction of the lithium-ion cell. The lithium added in excess in the form of LiF on the cathode side compensates for formation losses. The excess of lithium can be set precisely here, thus ensuring a higher energy density of the cell.

Both electrodes are conversion electrodes—that is, the active material of both electrodes participates in each of the charging and discharge reactions.

The discharge reaction of the cell leads to (exothermic) delithiation of the anode and lithiation of the cathode as follows:

[Cathode: 2 FeF₃]+[Anode: (2 Fe+6 Li₂O)])→

[Cathode: 2 (Fe+3 LiF)]+[Anode: Fe₂O₃]

The usual charging reaction (i.e., charging apart from the SEI-forming reaction) therefore results in (endothermic) lithiation of the anode and delithiation of the cathode as follows:

[Cathode: 2 (Fe+3 LiF)]+[Anode: Fe₂O₃]→

[Cathode: 2 FeF₃]+[Anode: (2 Fe+6 Li₂O)]

According to a second embodiment, the material nickel (II) fluoride (NiF₂) is employed on the cathode side in place of the iron (III) fluoride (FeF₃) conversion material. With this embodiment, the cathode has a composition, in a notation analogous to that for the first exemplary embodiment, of approximately 55 mol % Ni+2LiF and 45 mol % NiF₂. In the case of the anode, the composition is approximately 66 mol % 2 Fe+3 Li₂O and 33 mol % Fe₂O₃. The resulting formation reaction is:

(5 Ni+10 LiF+4 NiF₂)+(Fe₂O₃+4 Fe+6 Li₂O)→9 NiF₂+(6 Fe+9 Li₂O)+2 Li₂CO₃ (SEI)

The discharge reaction of the cell leads to delithiation of the anode and lithiation of the cathode as follows:

9 NiF₂+(6 Fe+9 Li₂O)→(9 Ni+18 LiF)+3 Fe₂O₃

The usual charging reaction (i.e., charging apart from the SEI-forming reaction) leads to lithiation of the anode and delithiation of the cathode as follows:

(9 Ni+18 LiF)+3 Fe₂O₃→9 NiF₂+(6 Fe+9 Li₂O)

According to a third embodiment, the compound copper (II) fluoride (CuF₂) is used instead of the compound nickel (II) fluoride (NiF₂). The reaction equations of the second embodiment are valid analogously for the third embodiment, with the element Ni replaced by the element Cu.

The advantages of the first embodiment obtain in the same way for the second and third embodiments. The specific differences between, for example, CuF₂ and FeF₃, such as the higher potential of CuF₂, for example, have no deleterious consequences for the advantages of the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A lithium-ion cell, comprising:
a positive electrode having an active material comprising a partially lithiated material; and
a negative electrode having an active material comprising a partially lithiated material.

2. The lithium-ion cell according to claim 1, wherein the partially lithiated material of the positive electrode is an active starting material of the positive electrode, and the partially lithiated material of the negative electrode is an active starting material of the negative electrode.

3. The lithium-ion cell according to claim 2, wherein the active starting material of the positive electrode comprises a mixture of a fluoride of a metal, an elemental metal, and lithium fluoride.

4. The lithium-ion cell according to claim 2, wherein the active starting material of the negative electrode comprises a mixture of an oxide of a metal, an elemental metal, and lithium oxide.

5. The lithium-ion cell according to claim 3, wherein the fraction of the fluoride of the metal in the active starting material of the positive electrode is at least 50 mol %.

6. The lithium-ion cell according to claim 4, wherein the fraction of the oxide of the metal in the active starting material of the negative electrode is at most 50 mol %.

7. The lithium-ion cell according to claim 3, wherein the metal is iron, nickel or copper.

8. The lithium-ion cell according to claim 4, wherein the metal is iron, nickel or copper.

9. A method for producing a lithium-ion cell having a positive electrode and a negative electrode, the method comprising the steps of:
mixing a first partially lithiated starting material for the positive electrode;
mixing a second partially lithiated starting material for the negative electrode;
producing the positive electrode using the first partially lithiated starting material as an active material for the positive electrode;
producing the negative electrode using the second partially lithiated starting material as an active material for the negative electrode;
installing the positive electrode and the negative electrode into a cell casing; and
sealing the cell casing.

10. The method according to claim 9, wherein the first partially lithiated starting material comprises a mixture of a fluoride of a metal, an elemental metal, and lithium fluoride.

11. The method according to claim 9, wherein the second partially lithiated starting material comprises a mixture of an oxide of a metal, an elemental metal, and lithium oxide.

12. The method according to claim 10, wherein the fraction of the fluoride of the metal in the first partially lithiated starting material is at least 50 mol %.

13. The method according to claim 11, wherein the fraction of the oxide of the metal in the second partially lithiated starting material is at most 50 mol %.

14. The method according to claim 9, wherein the second partially lithiated starting material comprises a mixture of an oxide of a metal, an elemental metal, and lithium oxide and the fraction of the oxide of the metal in the second partially lithiated starting material is at most 50 mol %, and wherein the first partially lithiated starting material comprises a mixture of a fluoride of a metal, an elemental metal, and lithium fluoride and the fraction of the fluoride of the metal in the first partially lithiated starting material is at least 50 mol %.

15. The method according to claim 10, wherein the metal is iron, nickel or copper.

16. The method according to claim 11, wherein the metal is iron, nickel or copper.
